(19) United States
(12) Patent Application Publication
(10) Pub. No.: US 2025/0368564 A1
(43) Pub. Date: Dec. 4, 2025

(54) CRYSTALLIZED GLASS AND PREPARATION METHOD THEREFOR

(71) Applicants: Yamashita YUTAKA, Hubei (CN); Ke ZHANG, Hubei (CN); Xintao LI, Hubei (CN); Weifang ZHANG, Hubei (CN); Morita EIMITSU, Hubei (CN); Rong LIU, Hubei (CN)

(72) Inventors: Yamashita YUTAKA, Hubei (CN); Ke ZHANG, Hubei (CN); Xintao LI, Hubei (CN); Weifang ZHANG, Hubei (CN); Morita EIMITSU, Hubei (CN); Rong LIU, Hubei (CN)

(21) Appl. No.: 19/017,806

(22) Filed: Jan. 13, 2025

(30) Foreign Application Priority Data
May 30, 2024 (CN) 2024106891732

(51) Int. Cl. C03C 10/00; C03B 32/02; C03C 21/00

(52) U.S. Cl. CPC C03C 10/0027; C03C 10/0009; C03B 32/02; C03C 21/002; C03C 2204/00

(57) ABSTRACT

A crystallized glass having the following oxides in mass percentage: 60.0%-70.0% SᵢO₂, 1.0%-5.0% P₂O₅, 0.1%-10.0% Al₂O₃, 3.1%-9.99% Li₂CO₃, 1.0%-3.0% K₂CO₃, 5.1%-12.0% Na₂CO₃, 1.0%-5.0% MgO, 0.01%-0.09% TiO₂, 1.0%-10.0% ZrO₂, 1.0%-2.0% SrO, 0.1%-0.9% La₂O₃, 0.1%-0.9% Y₂O₃, 1.0%-2.0% Nb₂O₅, 1.0%-2.0% Ta₂O₅, 0.1%-0.9% WO₃, 0.1%-0.9% Gd₂O₃, 0.1%-0.9% Bi₂O₃, and 0.1%-0.9% TeO₂. A preparation method for the crystalized glass is also provided.

### BACKGROUND OF THE INVENTION

The present invention relates to the technical field of glass products, and in particular, to a crystallized glass and a preparation method therefor.

In consumer products, glass covers are generally used in portable electronic devices, such as smartphones, tablets, and personal computers, to protect display screens. Protective glasses are also used in vehicle-mounted optical devices to protect, for example, lenses. Furthermore, in recent years, there has been a demand for the use of glass materials in casings of some packaging of electronic devices. In addition, there is an increasing demand for glass materials having high hardness and high light transmittance so that the devices using these glass materials can withstand severe environments during use. In view of the above, it is an object of the present invention to provide a crystallized glass that meets the current use requirements of glass materials.

### BRIEF SUMMARY OF THE INVENTION

In view of the problems and situations described above, it is an object of the present invention is to provide a crystallized glass. To attain the above object, the present invention provides the following technical solutions:

A crystallized glass, comprising the following oxides in mass percentage:
60.0%-70.0% SᵢO₂, 1.0%-5.0% P₂O₅, 0.1%-10.0% Al₂O₃, 3.1%-9.99% Li₂CO₃, 1.0%-3.0% K₂CO₃, 5.1%-12.0% Na₂CO₃, 1.0%-5.0% MgO, 0.01%-0.09% TiO₂, 1.0%-10.0% ZrO₂, 1.0%-2.0% SrO, 0.1%-0.9% La₂O₃, 0.1%-0.9% Y₂O₃, 1.0%-2.0% Nb₂O₅, 1.0%-2.0% Ta₂O₅, 0.1%-0.9% WO₃, 0.1%-0.9% Gd₂O₃, 0.1%-0.9% Bi₂O₃, and 0.1%-0.9% TeO₂.

Further, a predominant crystalline phase of the crystallized glass is a combination of cristobalite, lithium disilicate, and petalite.

Preferably, the predominant crystalline phase has a particle diameter of 1-100 nm, and a crystallinity of 30%-80%.

The present invention also provides a preparation method for a crystallized glass, comprising the following steps:
mixing raw materials evenly to obtain a mixture, melting the mixture, and then cooling the mixture to obtain a glass sheet, wherein the raw materials comprises the following oxides in mass percentage:
60.0%-70.0% SᵢO₂, 1.0%-5.0% P₂O₅, 0.1%-10.0% Al₂O₃, 3.1%-9.99% Li₂CO₃, 1.0%-3.0% K₂CO₃, 5.1%-12.0% Na₂CO₃, 1.0%-5.0% MgO, 0.01%-0.09% TiO₂, 1.0%-10.0% ZrO₂, 1.0%-2.0% SrO, 0.1%-0.9% La₂O₃, 0.1%-0.9% Y₂O₃, 1.0%-2.0% Nb₂O₅, 1.0%-2.0% Ta₂O₅, 0.1%-0.9% WO₃, 0.1%-0.9% Gd₂O₃, 0.1%-0.9% Bi₂O₃, and 0.1%-0.9% TeO₂;
subjecting the glass sheet to thermal nucleation treatment and crystal growth treatment to obtain the crystallized glass.

Preferably, the mixing of the raw materials is carried out in a mixer for a period of 5-60 min; the melting of the mixture is carried out in a quartz crucible, a zircon crucible, or a platinum crucible at a melting temperature of 1500-1700° C.

Preferably, the thermal nucleation treatment is carried out at a temperature of 500-850° C. for a period of 30-4000 min; the crystal growth treatment is carried out at a temperature of 500-850° C. for a period of 30-1800 min.

Further, the preparation method also comprises a step of subjecting the crystallized glass to grinding and polishing; soaking the crystallized glass ground and polished in a saline solution containing potassium or sodium; forming a compressive stress layer on a surface of the crystallized glass having soaked in the saline solution by a thermal strengthening treatment or an ion implantation method.

Preferably, the soaking is carried out for a period of 1-720 min, preferably 300-500 min; the saline solution has a temperature of 350-550° C.; the saline solution is potassium nitrate or sodium nitrate.

Preferably, the thermal strengthening treatment is specifically as follows: after heating the crystallized glass having soaked in the saline solution to 300-600° C., rapid cooling is carried out to form the compressive stress layer resulting from a temperature difference between the surface and an interior of the crystallized glass having soaked in the saline solution.

Preferably, the ion implantation method is specifically as follows: the surface of the crystallized glass having soaked in the saline solution is impacted with ions, and the ions are then implanted into the surface of the crystallized glass having soaked in the saline solution to form the compressive stress layer through an acceleration energy and acceleration voltage that do not damage the surface of the crystallized glass having soaked in the saline solution.

The present invention has the following beneficial effects: the crystallized glass of the present invention contains a compressive layer. By chemical strengthening of the compressive stress layer by using mixed acids or changing a sequence of single salt components, the technical effect of reducing a central compressive stress of the compressive stress layer can be achieved, and hence the crystallized glass of the present invention has a strong impact resistance, meaning that even if the glass is impacted and thus damaged, it is not easy to be broken into shattered fragments.

### DETAILED DESCRIPTION OF THE INVENTION

The composition and preparation method of the present invention are further described in detail below with reference to specific embodiments, but the present invention shall not be limited to the following embodiments and examples, instead, the present invention can be implemented with appropriate modifications within the scope of the object and purpose of the present invention.

In the following, mass percentages of the oxides mentioned below refer to the mass percentages of “converted oxides”, unless otherwise specified. Here, “converted oxides” means the oxides obtained if all the raw materials of the crystallized glass are decomposed (oxidized). A total mass percentage of all oxides obtained is 100%, and mass percentages of different oxides relative to the total mass of all oxides are expressed in their respective mass percentages. In the following, 0% refers to a mass percentage of 0%.

The present invention provides a crystallized glass, comprising the following oxides in mass percentage:
60.0%-70.0% SᵢO₂, 1.0%-5.0% P₂O₅, 0.1%-10.0% Al₂O₃, 3.1%-9.99% Li₂CO₃, 1.0%-3.0% K₂CO₃, 5.1%-12.0% Na₂CO₃, 1.0%-5.0% MgO, 0.01%-0.09% TiO₂, 1.0%-10.0% ZrO₂, 1.0%-2.0% SrO, 0.1%-0.9% La₂O₃, 0.1%-0.9% Y₂O₃, 1.0%-2.0% Nb₂O₅, 1.0%-2.0% Ta₂O₅, 0.1%-0.9% WO₃, 0.1%-0.9% Gd₂O₃, 0.1%-0.9% Bi₂O₃, and 0.1%-0.9% TeO₂.

SᵢO₂ is a glass-forming component that forms a network structure of the glass. If there are insufficient SᵢO₂, the resulting glass lacks chemical durability and has poorer devitrification resistance. In the present invention, an upper limit of the mass percentage of SᵢO₂ is preferably ≤70.0%, more preferably ≤69.0%, further preferably ≤68.0%, and most preferably ≤66.0%; a lower limit of the mass percentage of SᵢO₂ is ≥60.0%, more preferably ≥62.0%, further preferably ≥63.0%, and most preferably ≥64.0%.

The mass percentage of P₂O₅ is ≥1.0%; P₂O₅ is a nucleating agent during glass crystallization and can improve devitrification resistance of the glass. In particular, if the mass percentage of P₂O₅ is controlled to be no more than 5.0%, it can simultaneously improve the melting property of the glass and reduce the devitrification tendency of the glass. In the present invention, an upper limit of the mass percentage of P₂O₅ is ≤5.0%, more preferably ≤4.5%, and most preferably ≤4.0%.

When the mass percentage of Al₂O₃ is ≥0.1%, it can increase the viscosity of the glass during glass melting and improve the chemical durability of the glass. In particular, if the mass percentage of Al₂O₃ is controlled to be no more than 10.0%, it can simultaneously improve the melting property of the glass and reduce the devitrification tendency of the glass. In the present invention, an upper limit of the mass percentage of Al₂O₃ is preferably ≤10.0%, more preferably ≤5.0%, and most preferably ≤3.0%.

Li₂CO₃, K₂CO₃, and Na₂CO₃ are involved in ion exchanges during a chemical strengthening process, in which Li₂CO₃, K₂CO₃, and Na₂CO₃ are nucleating agents (auxiliary agents) of precipitated components after crystallization, and are also the object exchange substances of (K+) and (Li+) during ion exchanges; Li₂CO₃, K₂CO₃, and Na₂CO₃ have an effect of reducing the dissolution viscosity and prevent dissolution and devitrification (i.e. they are devitrification resistant components). However, these components may deteriorate chemical durability and permeation resistance when their mass percentages are too high. In the present invention, an upper limit of the mass percentage of Li₂CO₃ is ≤9.99%, and a lower limit thereof is ≥3.1%; an upper limit of the mass percentage of K₂CO₃ is ≤3.0%, and a lower limit thereof is ≥1.0%; an upper limit of the mass percentage of Na₂CO₃ is ≤12.0%, and a lower limit thereof is ≥5.1%.

MgO has an effect of reducing the viscosity of molten glass during glass melting. Preferably, an upper limit of the mass percentage of MgO is ≤5.0%, and a lower limit thereof is ≥1.0%.

TiO₂ has the effects of increasing a strain point of the glass and improving the chemical durability of the glass. Preferably, an upper limit of the mass percentage of TiO₂ is ≤0.09%, and a lower limit thereof is ≥0.01%.

ZrO₂ has the effects of increasing a strain point of glass and improving the chemical durability of glass. Preferably, an upper limit of the mass percentage of ZrO₂ is ≤10.0%, and a lower limit thereof is ≥1.0%.

SrO, when coexisting with MgO, reduces a high-temperature viscosity of molten glass, and has an effect of inhibiting devitrification. An upper limit of the mass percentage of SrO is ≤2.0%, and a lower limit thereof is ≥1.0%.

Both La₂O₃ and Nb₂O₅ have the effect of improving the refractive index of the glass. An upper limit of the mass percentage of La₂O₃ is ≤0.9%, and a lower limit thereof is ≥0.1%; an upper limit of the mass percentage of Nb₂O₅ is ≤2.0%, and a lower limit thereof is ≥1.0%.

Y₂O₃ can only achieve good effects when working together with Ta₂O₅, WO₃, and TeO₂. Particularly, an upper limit of the mass percentage of Y₂O₃ is ≤0.9%, and a lower limit thereof is ≥0.1%; an upper limit of the mass percentage of Ta₂O₅ is ≤2.0%, and a lower limit thereof is ≥1.0%; an upper limit of the mass percentage of WO₃ is ≤0.9%, and a lower limit thereof is ≥0.1%; an upper limit of the mass percentage of TeO₂ is ≤0.9%, a lower limit thereof is ≥0.1%. Use of a combination of these components within the above ranges of mass percentages has an effect of improving the strength and the elastic modulus of the glass.

Gd₂O₃ has an effect of reducing devitrification during glass melting and also acts as a nucleating auxiliary agent. An upper limit of the mass percentage of Gd₂O₃ is ≤0.9%, and a lower limit thereof is ≥0.1%.

Bi₂O₃ has the effects of reducing the viscosity of molten glass during glass melting and improving the meltability. An upper limit of the mass percentage of Bi₂O₃ is ≤0.9%, and a lower limit thereof is 0.1%.

The crystallized glass of the present invention has a skeleton structure as follows:

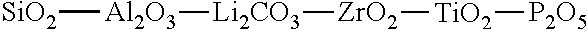

(MgO—SrO—La₂O₃—Y₂O₃—Nb₂O₅—Ta₂O₅—WO₃—Gd₂O₃—Bi₂O₃—TeO₂). This skeleton structure according the above formula provides rigidity. On the basis of this skeleton structure, the crystallized glass contains a compressive stress layer, wherein the crystallized glass contains K₂CO₃ and Na₂CO₃, which do not affect the skeleton structure after ion exchange and have relatively high physical strength. Further, the crystallized glass can remain colorless and transparent because it does not contain any coloring materials.

In summary, the present invention using the combination of components as detailed above results in a hard, colorless, and transparent crystallized glass.

In one embodiment: a predominant crystalline phase of the crystallized glass is a combination of cristobalite, lithium disilicate (Li₂O₅Si₂), and petalite (LiAlSi₄O₁₀), wherein the predominant crystalline phase has a particle diameter of 1-100 nm, and a crystallinity of 30%-80%.

The present invention also provides a preparation method for the above crystallized glass, comprising the following steps:

S1: mixing raw materials evenly to obtain a mixture, melting the mixture, and then cooling the mixture to obtain a glass sheet, wherein the raw materials comprises the following oxides in mass percentage:
60.0%-70.0% SᵢO₂, 1.0%-5.0% P₂O₅, 0.1%-10.0% Al₂O₃, 3.1%-9.99% Li₂CO₃, 1.0%-3.0% K₂CO₃, 5.1%-12.0% Na₂CO₃, 1.0%-5.0% MgO, 0.01%-0.09% TiO₂, 1.0%-10.0% ZrO₂, 1.0%-2.0% SrO, 0.1%-0.9% La₂O₃, 0.1%-0.9% Y₂O₃, 1.0%-2.0% Nb₂O₅, 1.0%-2.0% Ta₂O₅, 0.1%-0.9% WO₃, 0.1%-0.9% Gd₂O₃, 0.1%-0.9% Bi₂O₃, and 0.1%-0.9% TeO₂.

In one embodiment, the mixing of the raw materials is carried out in a mixer for a period of 5-60 min, and the mixer rotates at a speed of 1.0-30 rpm; the melting of the mixture is carried out in a quartz crucible, a zircon crucible, or a platinum crucible at a melting temperature of 1500-1700° C. for a period of 2-72 h; and the melting temperature is reduced to 1000-1450° C. at a start of the cooling of the mixture, and then the molten mixture are poured into a mold and slowly cooled to produce the glass sheet.

S2: subjecting the glass sheet to thermal nucleation treatment and crystal growth treatment to obtain the crystallized glass.

In one embodiment, the thermal nucleation treatment is carried out at a temperature of 500-850° C. for a period of 30-4000 min; the crystal growth treatment is carried out at a temperature of 500-850° C. for a period of 30-1800 min.

In a further embodiment of the present invention, the preparation method further comprises step S3:

S3: subjecting the crystallized glass to grinding and polishing.

In a further embodiment of the present invention, the preparation method further comprises step S4:

S4: soaking the crystallized glass ground and polished in a saline solution containing potassium or sodium.

In one embodiment, the soaking is carried out for a period of 1-720 min, preferably 300-500 min; the saline solution has a temperature of 350-550° C.; the saline solution may be potassium nitrate (KNO₃) or sodium nitrate (NaNO₃).

Step S4 also comprises the following steps:
forming a compressive stress layer on a surface of the crystallized glass having soaked in the saline solution by a thermal strengthening treatment or an ion implantation method.

In one embodiment, the thermal strengthening treatment is specifically as follows: After heating the crystallized glass having soaked in the saline solution to 300-600° C., rapid cooling is carried out to form the compressive stress layer resulting from a temperature difference between the surface and an interior of the crystallized glass having soaked in the saline solution. The ion implantation method is specifically as follows: The surface of the crystallized glass having soaked in the saline solution is impacted with ions, and the ions are then implanted into the surface of the crystallized glass having soaked in the saline solution to form the compressive stress layer through an acceleration energy and acceleration voltage that will not damage the surface of the crystallized glass having soaked in the saline solution.

The following experiments were performed to demonstrate the beneficial effects of the present invention. The specific experimental steps were as follows:

A crystallized glass is made in accordance with steps S1 and S2 as described above, wherein the platinum crucible is used for melting, and a total time for the thermal nucleation treatment and the crystal growth treatment is 5 hours. The obtained crystallized glass was analyzed by using a 200 kV field emission transmission electron microscope (i.e. FE-TEM) (specifically, model number JEM2100F made by Japan company JEOL Ltd.). The results showed that precipitated crystals with an average crystal diameter between 1-100 nm were observed. Through further confirmation from crystal lattice image of electron diffraction pattern and through EDX analysis, a combination of cristobalite, lithium disilicate (Li₂O₅Si₂), and petalite (LiAlSi₄O₁₀) was determined as the predominant crystalline phase. Crystal diameters of the precipitated crystals within a 180×180 nm² region were confirmed by using a TEM, and the average crystal diameter was then calculated.

The crystallized glass is further subject to the treatment of step S3 as described above, and a substrate with a thickness of 0.50 mm can be obtained, wherein said polishing is parallel polishing.

The crystallized glass after treatment of step S3 is further subject to chemical strengthening according to step S4 described above.

Evaluation and stress tests of the crystallized glass subject to the treatments according to steps S1 to S4 are detailed below:

The obtained crystallized glass subject to the treatments according to steps S1 to S4 was tested for the following physical properties. The results are shown in Tables 1-3, including results for of a weight per volume (g/cm³), surface compressive stress (CS) and a thickness of the compressive stress layer (depth of layer DOL_zero).

Examples 1-15 are the crystallized glasses according to the present invention, and comparative examples 1-2 are ordinary crystallized glasses (obtained by using the ingredients according to the prior art). The effects of the present invention can be achieved by crystallized glasses meeting the requirements of CS of 666.8-1156.7 MPa and DOL_zero of 138.9-200 μm. The surface compressive stress (CS) and the thickness of the compressive stress layer (depth of layer DOL) were determined by using a FSM-6000LE series glass surface stress meter manufactured by ORIHARA and a synthetically treated value determined by a scattered light photoelastic stress meter SLP-1000 or 2000 manufactured by ORIHARA respectively. A light source with a wavelength of 596 nm was selected as a light source for the measuring machine used in the CS test. The refractive index value at 596 nm was used for measuring the CS. The refractive index value at the wavelength of 596 nm was calculated from the refractive index measurement values at the wavelengths of C, d, F and g lines by second-order approximation according to the V-block method specified in JISB7071-2: 2018. The central compressive stress value (i.e. center tension, known as CT) was determined by Curve analysis.

TABLE 1

| | | Example | | | | | | |
|---|---|---|---|---|---|---|---|---|
| | | 1 | 2 | 3 | 4 | 5 | 6 | 7 |
| Oxide | SiO₂ | 61.87 | 60.83 | 62.26 | 62.53 | 60.57 | 70.00 | 60.00 |
| (mass %) | P₂O₅ | 1.30 | 2.20 | 2.40 | 2.33 | 1.88 | 1.33 | 1.86 |
| | Al₂O₃ | 6.44 | 8.88 | 7.02 | 7.77 | 7.66 | 4.19 | 10.00 |
| | Li₂CO₃ | 6.66 | 7.04 | 6.00 | 7.22 | 6.02 | 5.88 | 4.44 |
| | K₂CO₃ | 2.44 | 1.88 | 1.00 | 1.33 | 2.04 | 1.05 | 1.01 |
| | Na₂CO₃ | 5.11 | 5.84 | 5.66 | 5.15 | 6.66 | 5.11 | 5.66 |
| | MgO | 1.80 | 1.00 | 2.44 | 1.00 | 1.05 | 1.11 | 3.70 |
| | TiO₂ | 0.09 | 0.05 | 0.05 | 0.05 | 0.05 | 0.05 | 0.05 |
| | ZrO₂ | 5.78 | 3.88 | 4.77 | 4.22 | 5.67 | 2.88 | 4.88 |
| | SrO | 1.11 | 1.00 | 1.00 | 1.00 | 1.00 | 1.00 | 1.00 |
| | La₂O₃ | 0.90 | 0.90 | 0.90 | 0.90 | 0.90 | 0.90 | 0.90 |
| | Y₂O₃ | 0.90 | 0.90 | 0.90 | 0.90 | 0.90 | 0.90 | 0.90 |
| | Nb₂O₅ | 1.00 | 1.00 | 1.00 | 1.00 | 1.00 | 1.00 | 1.00 |
| | Ta₂O₅ | 1.00 | 1.00 | 1.00 | 1.00 | 1.00 | 1.00 | 1.00 |
| | WO₃ | 0.90 | 0.90 | 0.90 | 0.90 | 0.90 | 0.90 | 0.90 |
| | Gd₂O₃ | 0.90 | 0.90 | 0.90 | 0.90 | 0.90 | 0.90 | 0.90 |
| | Bi₂O₃ | 0.90 | 0.90 | 0.90 | 0.90 | 0.90 | 0.90 | 0.90 |
| | TeO₂ | 0.90 | 0.90 | 0.90 | 0.90 | 0.90 | 0.90 | 0.90 |
| | ZnO | | | | | | | |
| | SnO₂ | | | | | | | |
| | Total | 100.00 | 100.00 | 100.00 | 100.00 | 100.00 | 100.00 | 100.00 |
| Crystallized | Weight per | 2.43 | 2.44 | 2.45 | 2.46 | 2.39 | 2.40 | 2.49 |
| Glass | volume (g/cm³) | | | | | | | |
| | Transmittance | 92.90 | 91.50 | 92.90 | 92.20 | 92.80 | 91.00 | 91.80 |
| | (@550 nm) | | | | | | | |
| | Substrate | 0.50 | 0.50 | 0.50 | 0.50 | 0.50 | 0.50 | 0.50 |
| | thickness (mm) | | | | | | | |
| | Surface | 1111.1 | 666.8 | 732.9 | 1156.7 | 788.8 | 988.9 | 924.8 |
| | compressive | | | | | | | |
| | stress - CS | | | | | | | |
| | (Mpa) | | | | | | | |
| | Maximum | 138.9 | 140.9 | 189.7 | 155.6 | 138.9 | 168.0 | 141.9 |
| | depth of layer - | | | | | | | |
| | DOL_zero (μm) | | | | | | | |

TABLE 2

| | | Example | | | | | | | |
|---|---|---|---|---|---|---|---|---|---|
| | | 8 | 9 | 10 | 11 | 12 | 13 | 14 | 15 |
| Oxide | SiO₂ | 64.19 | 60.55 | 60.13 | 63.08 | 61.43 | 61.07 | 61.92 | 60.82 |
| (mass %) | P₂O₅ | 2.88 | 2.22 | 1.11 | 1.99 | 2.20 | 5.00 | 2.18 | 1.66 |
| | Al₂O₃ | 2.44 | 4.30 | 3.21 | 5.63 | 8.22 | 6.21 | 8.00 | 7.67 |
| | Li₂CO₃ | 5.80 | 5.02 | 9.99 | 4.88 | 6.88 | 6.16 | 5.80 | 6.88 |
| | K₂CO₃ | 3.00 | 1.10 | 1.00 | 1.20 | 1.51 | 1.33 | 1.00 | 1.22 |
| | Na₂CO₃ | 5.55 | 12.00 | 5.11 | 5.11 | 5.22 | 5.55 | 5.44 | 6.66 |
| | MgO | 1.03 | 1.00 | 1.00 | 5.00 | 1.00 | 1.11 | 1.11 | 1.11 |
| | TiO₂ | 0.05 | 0.05 | 0.05 | 0.05 | 0.09 | 0.06 | 0.09 | 0.09 |
| | ZrO₂ | 3.66 | 5.36 | 10.00 | 4.66 | 5.05 | 5.11 | 6.06 | 5.49 |
| | SrO | 2.00 | 1.00 | 1.00 | 1.00 | 1.00 | 1.00 | 1.00 | 1.00 |
| | La₂O₃ | 0.90 | 0.90 | 0.90 | 0.90 | 0.90 | 0.90 | 0.90 | 0.90 |
| | Y₂O₃ | 0.90 | 0.90 | 0.90 | 0.90 | 0.90 | 0.90 | 0.90 | 0.90 |
| | Nb₂O₅ | 2.00 | 1.00 | 1.00 | 1.00 | 1.00 | 1.00 | 1.00 | 1.00 |
| | Ta₂O₅ | 2.00 | 1.00 | 1.00 | 1.00 | 1.00 | 1.00 | 1.00 | 1.00 |
| | WO₃ | 0.90 | 0.90 | 0.90 | 0.90 | 0.90 | 0.90 | 0.90 | 0.90 |
| | Gd₂O₃ | 0.90 | 0.90 | 0.90 | 0.90 | 0.90 | 0.90 | 0.90 | 0.90 |
| | Bi₂O₃ | 0.90 | 0.90 | 0.90 | 0.90 | 0.90 | 0.90 | 0.90 | 0.90 |
| | TeO₂ | 0.90 | 0.90 | 0.90 | 0.90 | 0.90 | 0.90 | 0.90 | 0.90 |
| | ZnO | | | | | | | | |
| | SnO₂ | | | | | | | | |
| | Total | 100.00 | 100.00 | 100.00 | 100.00 | 100.00 | 100.00 | 100.00 | 100.00 |
| Crystallized | Weight per | 2.49 | 2.44 | 2.50 | 2.62 | 2.51 | 2.42 | 2.48 | 2.46 |
| Glass | volume (g/cm³) | | | | | | | | |
| | Transmittance | 91.60 | 92.90 | 91.80 | 92.50 | 91.70 | 91.90 | 91.50 | 91.90 |
| | (@550 nm) | | | | | | | | |
| | Substrate | 0.50 | 0.50 | 0.50 | 0.50 | 0.50 | 0.50 | 0.50 | 0.50 |
| | thickness (mm) | | | | | | | | |
| | Surface | 999.0 | 878.6 | 999.7 | 1066.8 | 989.9 | 866.8 | 1077.7 | 868.8 |
| | compressive | | | | | | | | |
| | stress - CS | | | | | | | | |
| | (Mpa) | | | | | | | | |
| | Maximum | 200.0 | 177.7 | 189.6 | 158.6 | 166.8 | 199.8 | 157.8 | 163.4 |
| | depth of layer - | | | | | | | | |
| | DOL_zero (μm) | | | | | | | | |

TABLE 3

Example

| | | Comparative | Comparative |
|---|---|---|---|
| | | Example 1 | Example 2 |
| Oxide | SiO₂ | 53.49 | 61.00 |
| (mass %) | P₂O₅ | 0.50 | |
| | Al₂O₃ | 14.95 | 15.00 |
| | Li₂CO₃ | | 1.00 |
| | K₂CO₃ | 12.75 | |
| | Na₂CO₃ | 10.98 | 4.00 |
| | MgO | 4.19 | 14.00 |
| | TiO₂ | | 5.00 |
| | ZrO₂ | 2.30 | |
| | SrO | | |
| | La₂O₃ | | |
| | Y₂O₃ | | |
| | Nb₂O₅ | | |
| | Ta₂O₅ | | |
| | WO₃ | | |
| | Gd₂O₃ | | |
| | Bi₂O₃ | | |
| | TeO₂ | | |
| | ZnO | 10.72 | |
| | SnO₂ | 0.12 | |
| | Total | 100.00 | 100.00 |
| Crystallized | Weight per | 2.67 | 2.58 |
| Glass | volume (g/cm³) | | |
| | Transmittance | 90.00 | 86.00 |
| | (@550 nm) | | |
| | Substrate | — | — |
| | thickness (mm) | | |
| | Surface | 1234.6 | 1456 |
| | compressive | | |
| | stress - CS | | |
| | (Mpa) | | |
| | Maximum | 39.8 | 18 |
| | depth of layer - | | |
| | DOL_zero (μm) | | |

It can be concluded from the above tables that all the crystallized glasses obtained by the embodiments of the present invention meet the requirements of CS being 666.8-1156.7 Mpa and DOL_zero being 138.9-200 μm. Accordingly, they can all achieve the technical effects of increasing the surface compressive stress of the compressive stress layer while reducing the central compressive stress, and having strong impact resistance, meaning that even if the glasses are impacted and thus damaged, they are not easy to be broken into shattered fragments.

The above descriptions are merely preferred embodiments of the present invention, and are not intended to limit the present invention in any form. The protection scope of the present invention shall be subject to the protection scope of the claims. Although the preferred embodiments of the present invention are disclosed above, the embodiments are not intended to limit the present invention. Any of those skilled in the art may make some changes or modifications according to the above disclosed technical content to form equivalent embodiments without departing from the scope of the technical solutions of the present invention. Any simple amendment, variations achieving the same technical effects, and modification made on the above embodiments according to the technical essence of the present invention without departing from the contents of the technical solutions of the present invention shall fall within the scope of the technical solutions of the present invention.

What is claimed is:

1. A crystallized glass, comprising the following oxides in mass percentage:
60.0%-70.0% SᵢO₂, 1.0%-5.0% P₂O₅, 0.1%-10.0% Al₂O₃, 3.1%-9.99% Li₂CO₃, 1.0%-3.0% K₂CO₃, 5.1%-12.0% Na₂CO₃, 1.0%-5.0% MgO, 0.01%-0.09% TiO₂, 1.0%-10.0% ZrO₂, 1.0%-2.0% SrO, 0.1%-0.9% La₂O₃, 0.1%-0.9% Y₂O₃, 1.0%-2.0% Nb₂O₅, 1.0%-2.0% Ta₂O₅, 0.1%-0.9% WO₃, 0.1%-0.9% Gd₂O₃, 0.1%-0.9% Bi₂O₃, and 0.1%-0.9% TeO₂.

2. The crystallized glass of claim 1, wherein a predominant crystalline phase of the crystallized glass is a combination of cristobalite, lithium disilicate, and petalite.

3. The crystallized glass of claim 2, wherein the predominant crystalline phase has a particle diameter of 1-100 nm, and a crystallinity of 30%-80%.

4. A preparation method for a crystallized glass, comprising the following steps:
mixing raw materials evenly to obtain a mixture, melting the mixture to obtain a molten mixture, and then cooling the molten mixture to obtain a glass sheet, wherein the raw materials comprises the following oxides in mass percentage:
60.0%-70.0% SᵢO₂, 1.0%-5.0% P₂O₅, 0.1%-10.0% Al₂O₃, 3.1%-9.99% Li₂CO₃, 1.0%-3.0% K₂CO₃, 5.1%-12.0% Na₂CO₃, 1.0%-5.0% MgO, 0.01%-0.09% TiO₂, 1.0%-10.0% ZrO₂, 1.0%-2.0% SrO, 0.1%-0.9% La₂O₃, 0.1%-0.9% Y₂O₃, 1.0%-2.0% Nb₂O₅, 1.0%-2.0% Ta₂O₅, 0.1%-0.9% WO₃, 0.1%-0.9% Gd₂O₃, 0.1%-0.9% Bi₂O₃, and 0.1%-0.9% TeO₂;
subjecting the glass sheet to thermal nucleation treatment and crystal growth treatment according to conventional prior art to obtain the crystallized glass.

5. The preparation method of claim 4, wherein the mixing of the raw materials is carried out in a mixer for a period of 5-60 min; and the mixer rotates at a speed of 1.0-30 rpm; the melting of the mixture is carried out in a quartz crucible, a zircon crucible, or a platinum crucible at a melting temperature of 1500-1700° C. for a period of 2-72 h; and the melting temperature is reduced to 1000-1450° C. at a start of the cooling of the molten mixture, and then the molten mixture are poured into a mold and slowly cooled to produce the glass sheet.

6. The preparation method of claim 4, wherein the thermal nucleation treatment is carried out at a temperature of 500-850° C. for a period of 30-4000 min; the crystal growth treatment is carried out at a temperature of 500-850° C. for a period of 30-1800 min.

7. The preparation method of claim 4, also comprising a step of subjecting the crystallized glass to grinding and polishing; soaking the crystallized glass ground and polished in a saline solution containing potassium or sodium; forming a compressive stress layer on a surface of the crystallized glass having soaked in the saline solution by a thermal strengthening treatment or an ion implantation method.

8. The preparation method of claim 7, wherein the soaking is carried out for a period of 1-720 min; the saline solution has a temperature of 350-550° C.; the saline solution is potassium nitrate or sodium nitrate.

9. The preparation method of claim 7, wherein the thermal strengthening treatment is as follows: after heating the crystallized glass having soaked in the saline solution to 300-600° C., rapid cooling is carried out to form the compressive stress layer resulting from a temperature difference between the surface and an interior of the crystallized glass having soaked in the saline solution.

10. The preparation method of claim 7, wherein the ion implantation method is as follows: the surface of the crystallized glass having soaked in the saline solution is impacted with ions, and the ions are then implanted into the surface of the crystallized glass having soaked in the saline solution to form the compressive stress layer.
